(19) United States
(12) Patent Application Publication
(10) Pub. No.: US 2025/0371483 A1
(43) Pub. Date: Dec. 4, 2025

(54) SYSTEMS AND METHODS FOR OBJECT TRACKING

(71) Applicant: FedEx Freight Corporation, Memphis, TN (US)

(72) Inventors: Trenton C. FOX, Harrison, AR (US); Neal TUCKER, Olathe, KS (US); Andrew JENSEN, Harrison, AR (US); Dane WORTLEY, Memphis, TN (US)

(21) Appl. No.: 18/733,388

(22) Filed: Jun. 4, 2024

(51) Int. Cl. G06Q 10/0833; G01G 19/12

(52) U.S. Cl. CPC G06Q 10/0833; G01G 19/12

(57) ABSTRACT

A system for associating an object transport vehicle to an object includes an object transport vehicle, at least one processor, and at least one non-transitory memory storing instructions. The object transport vehicle includes an object carrier, a weight sensor configured to measure weight on the object carrier, and at least two first tags configured to providing locations of the object transport vehicle, which is configured to transport objects with a second tag. The method for associating the object transport vehicle to the object include receiving a first location and a first weight of a first object, receiving a vehicle location of the object transport vehicle, and determining that the first object and the object transport vehicle are associated from a distance between the object and the object transport vehicle, a weight change on the object carrier, and a user verification.

### TECHNICAL FIELD

The present disclosure relates generally to the systems and methods for tracking objects. In particular, some embodiments of the present disclosure relate to methods and systems for determining association between an object and an object transportation vehicle during warehouse operations to enhance accuracy and efficiency, safety, and productivity.

### BACKGROUND

In warehouse logistics, the efficient movement of objects (i.e., freight) from one point to another is crucial for operational success. Object transportation vehicles, such as forklifts, play a pivotal role in this process, ensuring timely delivery and organization of goods. To facilitate smooth operations and accurate inventory management, warehouses often employ tracking systems to monitor the movement of both the objects and the object transportation vehicles within their premises.

Recently, automated systems are developed to allow tracking systems relying on methods such as distance measurement and weight changes to determine the association and disassociation of the objects and the object transportation vehicles. However, these methods are susceptible to errors, which can lead to inaccuracies in tracking object movements. Factors such as environmental conditions and equipment malfunctions can contribute to these inaccuracies, potentially resulting in disruptions to warehouse operations and inventory discrepancies.

To address these challenges, there is a need for an improved method of tracking object movements within a warehouse environment, especially the association and disassociation of objects to an object transportation vehicle. This method could minimize the occurrence of errors and enhance the reliability and accuracy of the tracking process. By mitigating the risks associated with existing tracking methods, warehouses can optimize their operations, improve inventory management, and ultimately enhance overall efficiency and productivity.

The disclosed method and system are directed to overcoming one or more of the problems set forth above by offering a more robust and reliable solution for tracking object movements in warehouse logistics.

### SUMMARY

The present disclosure includes a method and system that can accurately determine association and disassociation of objects with object transportation vehicles. Such capability would minimize the occurrence of errors and enhance the reliability and accuracy of the object tracking system in a warehouse setting.

Specifically, one aspect of the present disclosure is directed to a system for associating an object transport vehicle to an object. The system includes an object transport vehicle, at least one processor, and at least one non-transitory memory storing instructions. The object transport vehicle includes an object carrier, a weight sensor configured to measure weight on the object carrier, and at least two tags providing locations of the object transport vehicle. The object transport vehicle is configured to transport objects with a tag.

Another aspect of the present disclosure is directed to a method for associating the object transport vehicle to the object, including the steps of: receiving a vehicle location of the object transport vehicle, receiving a first location and a first weight of a first object, and determining that the first object and the object transport vehicle are associated by determining a first distance between the first location and the vehicle location remains below a threshold distance based on determining that the object transport vehicle has moved by at least a predetermined distance, receiving a weight carried by the object carrier from the weight sensor, determining that the weight carried by the object carrier is substantially consistent with the first weight, and prompting a user of the object transport vehicle to verify that the first object is loaded on the object carrier. In response to receiving a user verification that the first object is loaded on the object carrier, sending to the object transport vehicle a destination of the first object, and after the object transport vehicle arrives at the destination, sending instructions to the object transport vehicle to unload the first object. In response to receiving a user verification that the first object is not loaded on the object transport vehicle, disassociating the first object to the object transport vehicle.

Other systems and methods are also discussed herein.

### BRIEF DESCRIPTION OF THE DRAWINGS

FIG. 1 is an illustration of a warehouse, consistent with embodiments of this disclosure.

FIG. 2 is a schematic block diagram illustrating an embodiment of a system for associating and disassociating objects to an object transportation vehicle, consistent with embodiments of this disclosure.

FIG. 3 is a schematic block diagram illustrating an embodiment of a method for associating and disassociating objects to an object transportation vehicle, consistent with embodiments of this disclosure.

FIG. 4 is a schematic block diagram illustrating an embodiment of a method for disassociating objects to an object transportation vehicle, consistent with embodiments of this disclosure.

FIG. 5 is a schematic block diagram illustrating an embodiment of a method for associating objects to an object transportation vehicle, consistent with embodiments of this disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for determining the association and disassociation of an object to an object transportation vehicle in addition to using a wireless-based tracking system and weight sensors to enhance efficiency, safety, and productivity.

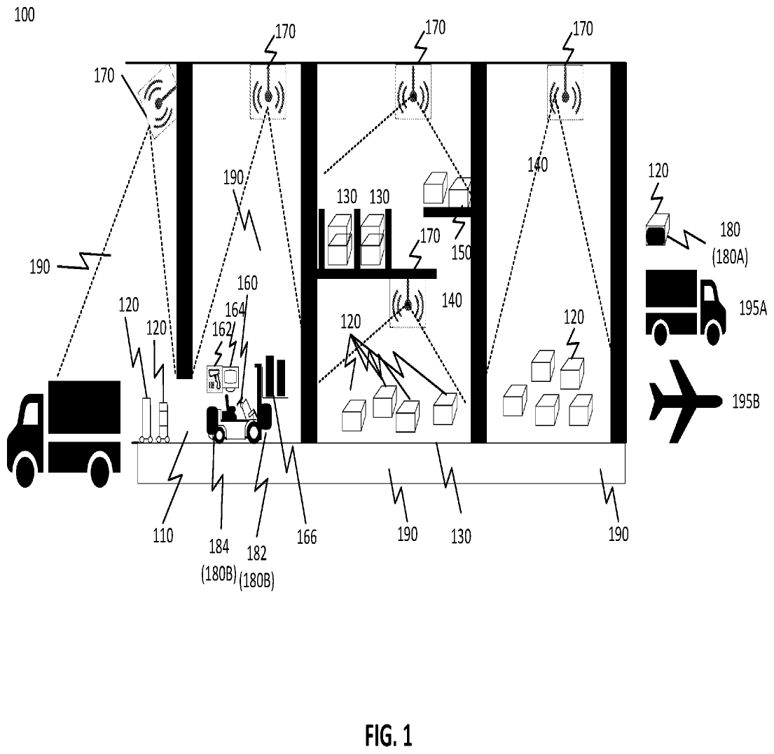

FIG. 1 is an illustration of a warehouse 100, consistent with embodiments of this disclosure. A warehouse is a space or facility designed for storage of goods, materials, merchandise, and other items. It serves as a central point in the supply chain where products or freight are temporarily held before they are shipped to retailers, wholesalers, or directly to customers. While using a warehouse as an example, the disclosed systems and methods may be generally applicable in a work site of different environment settings where objects (e.g., freight) are stored, organized, reorganized, loaded, and/or unloaded. In some embodiments, warehouse 100 and its details are electronically stored for simulation purposes; embodiments including these aspects are further discussed below.

In some embodiments, warehouse 100 may have at least one door 110 for receiving and putting away object 120. In some embodiments, warehouse 100 may have separate doors 110 for receiving object 120 and putting away object 120. In some embodiments, warehouse 100 may have multiple areas. The multiple areas may be divided or subdivided based on function or location. For example, warehouse 100 may have a loading/unloading area, corridor, storage area, transitioning area, etc. A storage area may be further subdivided into multiple numbered sub-areas, or may be further subdivided into sub-areas for different type of object, e.g., pallet area, machinery area, refrigerated area, area with environmental control (e.g., temperature and/or humidity control), etc.

In some embodiments, warehouse 100 may have a plurality of storage bays 130. Each of the plurality of storage bays 130 may have at least one level 140. In other words, each storage bays 130 may be able to keep object 120 stacked. In some embodiments, multiple pieces of object 120 may be stacked in a same storage bay 130 on different shelves 150. In some embodiments, multiple pieces of object 120 may stack on each other without shelves 150, for example, one object 120 may stack on another object 120 directly with their pallets on.

In some embodiments, object 120 may refer to goods and cargo that are being stored, handled, and transported in, to, or from warehouse 100. In some embodiments, object 120 may be palletized goods, loose cartons or boxes, bulk goods, barrels, drums, crates, rolls, coils, caged goods, or the like. In some embodiments, object 120 may be a machinery, cars, trucks, or other vehicles or heavy machines. In this disclosure, object 120 may be generally referred to as “objects” being tracked. In some embodiments, object 120 may have a recorded weight and size. In some embodiments, database (e.g., database 230) may store data indicating the weight and size of object 120, and ready for queries by processors (e.g., processor 210).

In some embodiments, warehouse 100 may have a plurality of object transport vehicles 160 operating in warehouse 100. An object transport vehicle 160 is a moving vehicle with the capability to carry at least one piece of object with it. For example, an object transport vehicle 160 may be a forklift, a pallet jack (i.e., hand trucks,) an automated guided vehicle (AGV), a tow tractor, a tugger, a reach truck, a cart (i.e., push cart, a shelving cart,) a dolly, a scissor lift, a crane system (e.g., a bridge crane or a gantry crane,) a tilt truck, or a robotic transporting system.

In some embodiments, each of the object transport vehicles 160 may have a user input device 162 (e.g., 162A, 162B, 162C, 162D, etc.) that is associated with the object transport vehicle 160. In some embodiment, a user of the object transport vehicle 160 may use the user input device 162 to provide user input to the object transport vehicle 160 or the system. In some embodiments, the user input device 162 may be a handheld scanner, a smartphone or tablet with scanner app, portable data terminals, radio frequency identification (RFID) readers, mobile computers, wearable scanners, etc.

In some embodiments, each of the object transport vehicles 160 may also have a terminal displaying device 164. In some embodiments, the terminal displaying device 164 may be integrated to the object transport vehicle 160 and/or the user input device 162. For example, a smartphone with a scanner app may serve as both a terminal displaying device 164 and a user input device 162. For another example, a tablet with scanner attachments may serve as both a terminal displaying device 164 and a user input device 162 and is integrated to the object transport vehicle 160.

In some embodiments, each of the object transport vehicles 160 may also have an object carrier 166. In some embodiments, the object carrier 166 may carry objects 120 so objects 120 may travel with the object transport vehicles 160. In some embodiments, the object carrier 166 may be in the front of the object transport vehicle 160. For example, an object carrier 166 may be the fork on a forklift, and the fork is on the front part of the forklift. In some embodiments, the object carrier 166 may be in the back of the object transport vehicle 160. For example, an object carrier 166 may be the trunk of a truck, and the trunk is on the back part of the truck.

In some embodiments, each of the object transport vehicles 160 may also have a weight sensor (not shown) configured to measure weight on the object carrier 166. In some embodiments, the weight sensor may measure the weight or force exerted on it. Specifically, the weight sensor may measure the weight of an object (e.g., 120) that the object carrier 166 carries. In some embodiments, the weight sensor may measure weight carried on the object carrier 166 in increments. In some embodiments, the weight sensor may transmit the weight it reads to the object transport vehicle 160 and/or the system for further processing. In some embodiments, the weight sensor may transmit the weight it reads through a wire connection or wirelessly.

In some embodiments, warehouse 100 may have its space divided into zones. In some embodiments, the zones may be identical in size and shape, except on the perimeter of warehouse 100 where the boundaries of warehouse 100 prohibits so. In some embodiments, the zones may be defined by a grid of rectangular shaped areas (i.e., cells). Each of the zones may be identified by a set of coordinates. In some embodiments, object 120 may be organized next to each other on the floor of warehouse 100 so no shelves 150 is needed. In such case, a top view of the warehouse floor (i.e., a floor plan or floor map) may be sufficient to display and monitor the locations of object 120 and object transport vehicle 160. In some embodiments, users may refer to zones as an alternative of coordinates for the purposes of locating tags and/or communicating the locations of the tags between subsystems and between the system and user. In some embodiments, users and the system may use zones as a measurement of distance because the zones are in most cases identical in size and shape.

In some embodiments, warehouse 100 may have a plurality of tag readers 170 installed in or near warehouse 100. Tag readers may be antennas, sensors, or any signal receivers that may actively or passively obtain or receive information stored in a tag. In some embodiments, the installation locations of tag readers 170 may align with the zones of warehouse. For example, the installation locations of tag readers 170 within one zone are identical to the installation locations of tag readers 170 within other zones. In some embodiments, the number of the tag readers 170 installed within each zone is the same, and their installation locations within each zone might be different to accommodate the building structure and constraints of each zone. In some embodiments, tag readers 170 may be placed in a honeycomb pattern to maximize covered areas.

In some embodiments, a tag 180 may be a device or object that contains information and is equipped with a unique identifier. The unique identifier may distinguish itself from other tags 180 in the system. In this disclosure, tag 180 may refer to tags 180A attached to objects (i.e., freight) 120 and tags 180B attached to object transport vehicles 160 (e.g., front tag 182 and back tag 184). In some embodiments, a tag 180 may have a memory component that stores data, which may include information such as the unique identifier (e.g., an identification number) and other relevant information associated with tag 180. In some embodiments, tag 180 may be a passive tag, i.e., the tag does not have an internal power source and rely on the energy provided by tag reader 170 during communication with the tag reader 170. In some embodiments, tag 180 may be an active tag, i.e., the tag has its own power source (e.g., battery) to actively transmit data to tag reader 170. An active tag can generally operate at greater distances than passive tags. Some tag brands, for example, include Avery Dennison/Smartrack, Beontag/Confidex, Nam Viet, Checkpoint, Omni-ID, etc.

In some embodiments, tag 180 may be operative in different frequencies in different ranges. In some embodiments, tag 180 may encode different information for different frequencies. In some embodiments, the specific frequencies tag 180 is operative in may be for determined by the system administrators and tag readers 170. For example, tag 180 may be operative in the Ultra-high frequency (UHF) range to allow tracking by tag reader 170; tag 180 may be operative in the Low-frequency (LF) range to allow scanning by a user with a handheld device. In some embodiments, operating frequencies may dictate a reading range of the tag reader 170. In some embodiments, depending on the frequencies tag 180 being operative in, processor (e.g., processor 210) may calculate a reading range for simulation purposes. That is, depending on operative frequencies of tag 180, processor (e.g., processor 210) may calculate a reading range and apply the calculated reading range in determining tag reader 170 placements.

In some embodiments, tag 180 in the disclosed system may be passive or active, or a combination of passive tags and active tags. In some embodiments, tag 180 may be sticker tags, inlay/insert tags, or hard tags installed on object transport vehicles 160 and draw power from them. In some embodiments, the system may track tag 180A on object 120 and vehicle tag 180B on object transport vehicles 160 similarly.

In some embodiments, the plurality of tag readers 170 may be positioned on an elevated location above the warehouse floor, for example, on or near the inside of warehouse ceiling, on columns, beams, or walls of warehouse 100, on a standalone post or pole, or on suspended wires above the floor.

In some embodiments, tag readers 170 may receive signals (e.g., read a tag wirelessly) within a certain angle. Because tag reader 170 is positioned above the floor, when unobstructed (e.g., by shelves, bays, walls, columns, pipes and other utilities in warehouse 100), tag reader 170 may cover a conical area 190, with tag reader 170 being at the vertex of a conical area 190. In some embodiments, the angle may be larger than 180 degrees, and even a full 360 degrees. Therefore, the conical area becomes a spherical frustum (i.e., a sphere with the tag reader at the center minus a spherical cap created by the warehouse floor.) In case the angle is larger than 180 degrees but less than 360 degrees, the area 190 below tag reader 170 is the same as the area 190 in case the angle is a full 360 degrees. In some embodiments, conical area 190 or the spherical frustum area may be incomplete due to structures of warehouse 100 (e.g., columns, beams, walls, shelves) blocking some area off. In this disclosure, the area covered by a tag reader 170 may be referred to as a conical area 190, even if it may be a spherical frustrum and/or being incomplete due to other structures' blocking.

In some embodiments, because of the arrangements of tag readers 170 in warehouse 100 and/or conical area 190 being incomplete, conical areas 190 from adjacent tag readers 170 may overlap or leave a gap that is not covered. Because each tag reader 170 covers a conical area 190, which projects at different height a circle of different size, the overlapping areas and gaps may vary at different elevations. In some embodiments, the projected circles may be overlaid with the floor plan of warehouse 100 to demonstrate signal coverage of the tag readers 170.

In some embodiments, each of the multiple pieces of object 120 and object transport vehicles 160 may have a tag 180 (i.e., 180A and 180B) attached or affixed to it, and thus associated with tag 180 through the tag's unique identifier. In some embodiments, the associations between object 120 or object transport vehicle 160 and the corresponding tag's unique identifier may be stored on one or more database in the one or more non-transitory memory. In some embodiments, each of the object transport vehicles 160 may have at least two tags 180B.

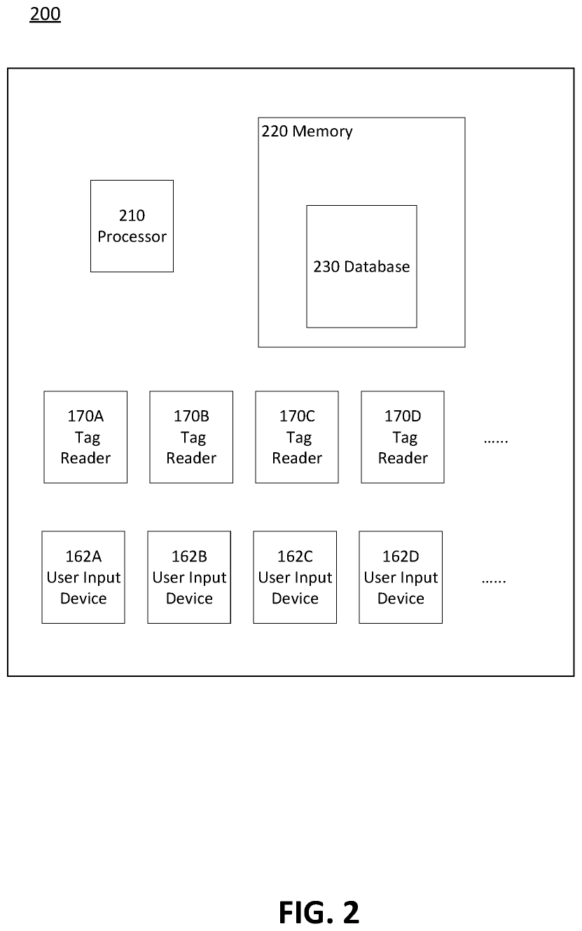

FIG. 2 is a schematic block diagram illustrating an embodiment of a wireless system 200 for associating and disassociating objects to an object transportation vehicle, consistent with embodiments of this disclosure. In some embodiments, system 200 may include at least one processor 210 and at least one memory 220. In this disclosure, the at least one processor 210 refers to processors in general, and may be processors in a server, a desktop computer, and/or a mobile device (e.g., laptop, smartphone).

In some embodiments, memory 220 may be transitory and/or non-transitory. In some embodiments, non-transitory memory refers to memory that may retain data even when power is turned off or the system is shut down; transitory memory may refer to memory that may retain data only while power is supplied to it and loses the data stored in it when the power is turned off. In some embodiments, non-transitory memory may store instructions, which when executed perform methods for tracking object locations, as described in various embodiments of this disclosure. In some embodiments, transitory memory may store temporary information, for example, calculated locations within a preset length of time. In some embodiments, non-transitory memory 220 may be hard disk drives (HDDs), Solid-State Drives (SSDs), or flash memory in local or remote servers, or on cloud servers. In some embodiments, the at least one non-transitory memory 220 may be multiple memories on different servers, each memory 220 may perform one or more functions similar or different from other memories 220. In some embodiments, the at least one transitory memory 225 may be Random Access Memory (RAM) or cache memory. In this disclosure, when not specifically distinguished, memory 220 may refer to non-transitory memory 220 or transitory memory 225. In some embodiments, system 200 may include at least one database 230 stored on memory 220. In some embodiments, database 230 may store information about warehouse 100, the multiple pieces of object 120 being tracked, object transport vehicles 160 used to move the multiple pieces of object 120. In some embodiments, database 230 may include algorithms (e.g., calculation processes, different element weights in averaging calculations, or any other rules and procedures in executing the disclosed methods.)

In some embodiments, each piece of object 120 has a weight. In some embodiments, each piece of object 120 has a size. In some embodiments, both weight and size are stored in database 230 and available for processors 210 to obtain upon request. In some embodiments, the weight of object 120 may include, in addition to the weight in number of pounds or kilograms, a distribution of weight, for example, the center of gravity. In some embodiments, the size of object 120 may include its outside packaging dimensions in length, width, and height. For example, the size of a pallet of good may include 48 inches in length, 40 inches in width, and 72 inches in height. In some embodiments, the size of object 120 may include additional information if it is irregular (i.e., not a regular shape that can be described in length, width, and height, e.g., asymmetric, freeform, or complex contoured.)

In some embodiments, warehouse 100 may have a coordinate system established to describe locations. In some embodiments, the coordinate system may be a 2-dimensional system. In some embodiments, the coordinate system may be a 3-dimensional system. In some embodiments, the coordinate system may be a Cartesian coordinate system with two coordinates (i.e., x-coordinate and y-coordinate) representing the horizontal position on the floor plane and a third coordinate (z-coordinate) representing the vertical position, i.e., height. In some embodiments, other coordinate systems may be adopted.

In some embodiments, the vehicle location of an object transport vehicle 160 may also include one or more orientations or directions. In some embodiments, the one or more orientation or direction is reflection of present status of object transport vehicle 160 and therefore stored in transitory memories. For instance, a vehicle location of an object transport vehicle 160 may include, not only its position in the coordinate system, but also the direction it is facing (e.g., the direction the fork of a forklift is pointing to.) For another instance, the location of an object transport vehicle 160 may also include its moving direction, which is the direction it is moving towards, and may or may not be the same as the direction an object transport vehicle is orienting at. In some embodiments, processor 210 may calculate the moving direction from comparing the present position to an earlier position. For yet another instance, the location of a tag reader 170 may include its position in the coordinate system, as well as its orientation and angle. In some embodiments, the orientation of a tag reader 170 may indicate a nominal direction (i.e., the center direction of the tag reader's coverage) tag reader 170 is facing projected on the floor or warehouse 100. In some embodiments, the angle of a tag reader 170 may be angle between the nominal direction and the horizontal plane (i.e., the floor of warehouse 100).

In some embodiments, all information of warehouse 100, for example, floor plan of warehouse 100, grid of zones, locations of tag readers 170 and their conical projections on warehouse floor, locations and moving direction and speed of tags 180 (e.g., 180A and 180B), locations and moving directions and speed of object transport vehicles 160, etc. may be stored in a database on memory 220, either on non-transitory memory or on transitory memory. In some embodiments, all information of warehouse 100 as mentioned above can all overlap because they have coordinates in a same coordinate system. Therefore, system 200 may display all the information as mentioned above all at once on a displaying device (e.g., a monitor, screen, printer, signboard, or other visual system). In some embodiments, system 200 may allow a user to select which information to display on the displaying device.

While an object transport vehicle 160 typically moves on the floor level, in some embodiments, a z-coordinate of the location may indicate the operating height of object transport vehicle 160. For example, a forklift may move on the warehouse floor, where only x- and y-coordinates are needed for locating the forklift, and its z-coordinate may indicate the height of the fork blades. In other words, the location in the tag read may indicate that the forklift is operating (e.g., loading or unloading objects) at this height. In some embodiments, the tolerances may be dictated by the tag's operative frequency, the tag reader specification, and use environment (e.g., temperature, humidity, or any other environmental conditions that may impact the data transmission between the tag and the tag reader).

In some embodiments, the z-coordinate of the location may be corrected by the referencing the operating status of object transport vehicle 160. For example, the processor (e.g., processor 210) may consider a separate communication with the forklift reporting its fork blade operating height, and use this information to correct z-coordinate of a corresponding tag read at the same moment.

In some embodiments, information about warehouse 100 may include the warehouse dimensions, floor plans, ceiling heights, door locations (e.g., dock doors, emergency exits), tag operative frequencies, tag reader specifications and installation locations, racking and storage system locations and types, climate control (e.g., temperature and humidity control and maps), security measures (e.g., access control, surveillance locations and capabilities). In some embodiments, the locations and dimensions may be at least in part using the coordinate system. For example, the information about a door 110 may include its size, location, and open direction, which may be described at least in part through its coordinates (e.g., at least one coordinate for a key point of the door, and/or length of the door, its swinging direction and sweeping area). In some embodiments, this information may be stored in database 230 as coordinate pairs or a set of coordinates. In some embodiments, the processor 210 may consider multiple pieces of object 120 in warehouse 100 generally as objects being tracked. Because each object 120 or object transport vehicle 160 has a corresponding tag 180 (e.g., 180A or 180B), which has a unique identification, any processor 210 may associate object 120 or object transport vehicle 160 and its corresponding tag 180 or tag unique identifier. In some embodiments, database 230 may store associations of tag 180 or tag unique identifier and their corresponding object 120 or object transport vehicle 160. In some embodiments, database 230 may provide the tag-object/object transport vehicle association to system 200 for further processing.

In some embodiments, the plurality of tag readers 170A, 170B, 170C, 170D (or collectively, 170 to include all tag readers alike) in warehouse 100 may receive signals from tag 180 (i.e., tag reads) wirelessly and transmit the tag reads to system 200 (e.g., to any processor 210) for processing. In some embodiments, tag reads may refer to this tag 180 to tag reader 170 communication, which may be active or passive, as discussed above.

In some embodiments, the signal may include one or more report of its location and a corresponding time stamp. The one or more report of the tag location from the tag-tag reader communication is referred to as a raw location. In some embodiments, tag reader 170 may read a tag 180, and calculate multiple locations from the raw locations using different preset algorithms provided with tag reader 170 on exact cadence. In some embodiments, tag reader 170 may publish the reader-calculated locations to different processors according to preset rules. In some embodiments, this reader-calculated location is tag-specific, i.e., the reader-calculated location is a calculated location of tag 180 and corresponds to single tag reader to tag communication. In some embodiments, tag reader 170 may include a transitory memory 225 to temporary store tag reads, the raw locations, and the reader-calculated locations.

Similar to the tag reads of the multiple pieces of object 120, in some embodiments, the plurality of tag readers 170 in warehouse 100 may read vehicle tags 180B (e.g., front tag 182 and back tag 184) wirelessly and transmit the tag reads to system 200 for processing. In some embodiments, tag reads may include one or more report of its location (i.e., raw location) and a corresponding time stamp. In some embodiments, tag reader 170 may similarly calculate multiple reader-calculated locations using different preset algorithms on exact cadence, and publish the reader-calculated locations to different processors according to preset rules.

In some embodiments, tag reader 170 publishes all reader-calculated locations to system 200 for processing. In some embodiments, system 200 receives, in the signal, all reader-calculated locations and indications of each of the reader-calculated locations and their corresponding algorithm (e.g., processing windows) and timestamp. Therefore, system 200 may extract from one or more reader-calculated locations, their corresponding preset algorithm used, and their corresponding time, from one signal.

In some embodiments, the processor 210 may further process the reader-calculated locations of tag 180 (i.e., 180A or 180B) to improve the location accuracy on the system level (e.g., additional processing to account for jitters). In some embodiments, processor 210 may then query database 230 for association between tag 180 unique identifier and object 120 or object transport vehicle 160. In some embodiments, processor 210 may associate the reader-calculated locations to corresponding object 120 or object transport vehicle 160 at the time of the time stamp. In some embodiments, the reader-calculated locations may use the same coordinate system as warehouse 100. In some embodiments, each reader-calculated location may have tolerances. In some embodiments, the tolerances may be dictated by the tag reader's specification and use environment (e.g., temperature, humidity, or any other environmental conditions that may impact the data transmission between the tag and the tag reader.)

In some embodiments, warehouse 100 may have at least one object transport vehicle 160 to move one or more object 120 in warehouse 100, i.e., change locations together with object 120. In some embodiments, object transport vehicle 160 may also load or unload object 120, i.e., accept object 120 into warehouse 100, or transfer them out of warehouse 100 (e.g., to truck 195A or airplane 195B). In some embodiments, object transport vehicle 160 may also arrange or rearrange object 120 inside warehouse 100, for example, from one storage bay 130 to another, or within a storage bay 130. In some embodiments, the disclosed system and method may be applicable in, for example, an airport cargo loading area, and the object transport vehicle may be in different forms, for example, a truck 195A, an airplane 195B, etc.

In some embodiments, warehouse 100 may have more than one object transport vehicle 160. Each object transport vehicle 160 may have a tag 180B associated with it. In some embodiments, each object transport vehicle 160 may have at least two tags 180B (e.g., front tag 182 and back tag 184) associated with it. For example, an object transport vehicle 160 may have a front tag 182 and a back tag 184. By determining locations of both tags 182 and 184, processor 210 may determine the orientation of object transport vehicle 160. In some embodiments, with the orientation of object transport vehicle 160 known, processor 210 may determine distance between object 120 to not only object transport vehicle 160, but also object carrier 166. While in this example, the two tags 182 and 184 are placed on the front end and the back end of the object transport vehicle, a person of ordinary skill would understand that, having two tags placed on any two places of object transport vehicle 160 would have the same effect and allow the processor 210 to determine the orientation of object transport vehicle 160.

In some embodiments, vehicle tag 180B for object transport vehicles 160 may be the same as the tags used for the multiple pieces of object. In some embodiments, vehicle tag 180B (e.g., front tag 182, back tag 184) for object transport vehicles 160 may be different from tags 180A used for the multiple pieces of object 120 in form but share a same frequency, so they may all be read, tracked and monitored by the same tag reader 170 in system 200 at the same time. In some embodiments, database 230 may record the association of vehicle tags 180B for object transport vehicles 160 and their corresponding object transport vehicle 160 and provide such association upon request.

In some embodiments, each of the object transport vehicle 160 may have a maximum travel speed. In some embodiments, this maximum travel speed may be dictated by the object transport vehicle's own specification. In some embodiments, system 200 may store the maximum travel speed of an object transport vehicle 160 in memory 220 and make it available upon inquiry. In some embodiments, different object transport vehicles 160 may have different maximum speeds. For example, there may be object transport vehicles 160 of different make and model, therefore have different maximum speeds. In some embodiments, system 200 may associate the maximum travel speed of a specific object transport vehicle 160 to its tag unique identifier. In some embodiments, when processor 210 generate virtual vehicle tags for virtual object transport vehicles, users may specify the virtual object transport vehicle's make and model to allow processor 210 to properly assign maximum speeds to the virtual tags representing the virtual object transport vehicle. In some embodiments, processor 210 may obtain the virtual object transport vehicle's make and model and assign maximum speeds to the virtual tags representing the virtual object transport vehicle. In some embodiments, processor 210 may directly obtain the maximum speeds of the virtual object transport vehicle and accordingly apply the maximum speeds to the virtual tags representing the corresponding virtual object transport vehicle.

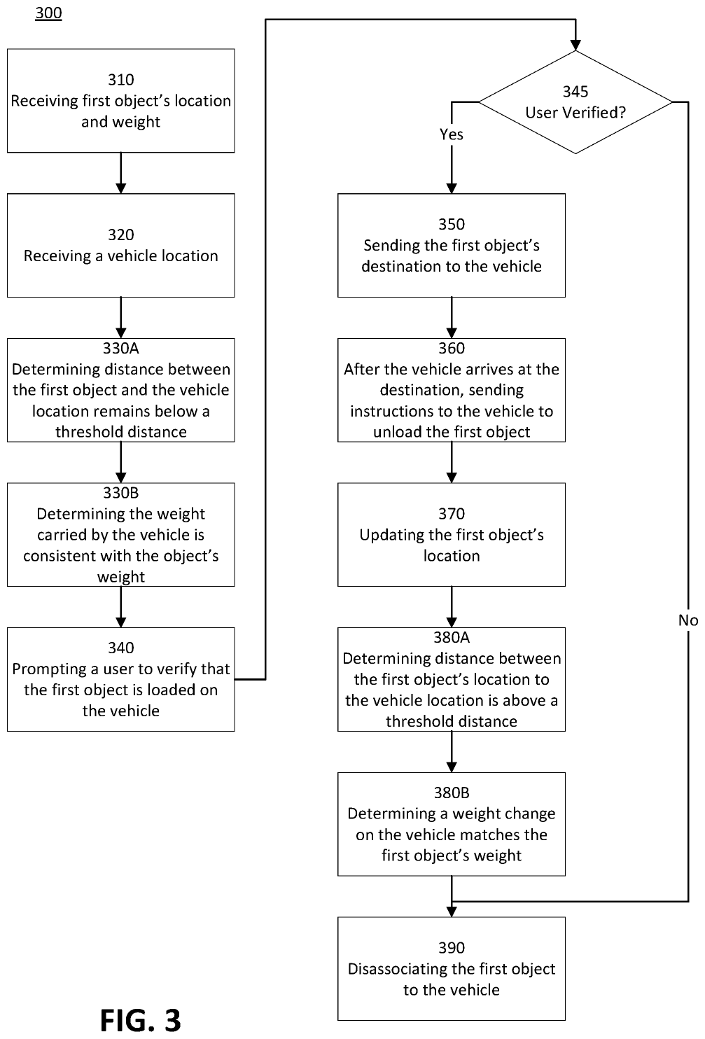

FIG. 3 is a schematic block diagram illustrating an embodiment of a method for associating and disassociating objects to an object transportation vehicle, consistent with embodiments of this disclosure. In some embodiments, the process in FIG. 3 may be executed by one or more of processor 210.

In some embodiments, in step 310, processor 210 may receive a location and a weight of an object 120. In some embodiments, the location may be a pair of coordinates. In some embodiments, the location may be a zone number, a bay number, a shelf number and level, or a combination of zone, bay, shelf, or any locating identifier that may locate the object. In some embodiments, the location may be a combination of locating identifiers and coordinates.

In some embodiments, in step 320, processor 210 may receive a vehicle location of the object transport vehicle 160. In some embodiments, the vehicle location of object transport vehicle 160 may be a position and a direction. In some embodiments, because object transport vehicle 160 has a front tag 182 and a back tag 184, the vehicle location may be two pairs of coordinates, and processor 210 may calculate the direction of object transport vehicle 160 from the two pairs of coordinates. In some embodiments, processor 210 may generate a vector from the location of back tag 184 to the location of front tag 182, and use the vector as the direction of object transport vehicle 160. In some embodiments, processor 210 may further calibrate the direction of the vehicle to accommodate vehicle tag 180B (e.g. front tag 182 and back tag 184) installation position variations. In some embodiments, calibration of the vehicle's direction vector may include adjusting the vector's direction by comparing it to the actual direction of object transport vehicle 160. For example, if front tag 182 is installed on the right side of the front of object transport vehicle 160 and back tag 184 is installed on the left side of the back of object transport vehicle 160, processor 210 may adjust the direction vector from back tag 184 to front tag 182 counterclockwise to accommodate the tag installation, so that the vector direction and the actual direction of object transport vehicle converge. In some embodiments, the location may be a zone number, a bay number, a shelf number and level, or a combination of zone, bay, shelf, or any locating identifier that may locate the object, as well as a direction. In some embodiments, the location may be a combination of locating identifiers, directions and coordinates.

In some embodiments, processor 210 may determine that an object 120 and an object transport vehicle are associated. In some embodiments, having an object 120 and an object transport vehicle associated means that the two are locked together, and that they share a same location (e.g., position and moving direction) at any time they remain associated. In some embodiments, processor 210 may use the vehicle location and the location of object 120 interchangeably. In some embodiments, processor 210 may assign an “in transit” status to object 120 that has an association with object transport vehicle 160 that it is being transported to its next destination. In some embodiments, determining that the object and the object transport vehicle 160 are associated may include multi-substeps.

In some embodiments, in step 330A, processor 210 may determine a distance between the location of object 120 and the vehicle location remains below a threshold distance based on determining that object transport vehicle 160 has moved by at least a predetermined distance. In some embodiments, processor 210 may calculate a distance between the location of object 120 and the vehicle location in the coordinate system. In some embodiments, the distance may be a Euclidean distance.

In some embodiments, processor 210 may determine the distance based on locations of tags 180A and 180B. For example, the distance between an object 120 having a tag 180A and an object transport vehicle 160 having two tags 180B (e.g., front tag 182 and back tag 184) is the Euclidean distance between location based on tag 180A and location based on tags 180B (e.g., an average of locations of front tag 182 and back tag 184).

In some embodiments, object transport vehicle 160 may further comprise a proximity sensor configured to determine the distance between object transport vehicle 160 and object 120. A proximity sensor works by detecting the presence or absence of an object within their sensing range without any physical contact. In some embodiments, proximity sensors may use different technologies for the detection, for example, inductive proximity sensors use electromagnetic fields to detect metallic objects; capacitive proximity sensors detect objects based on changes in capacitance in a generated electrostatic field; ultrasonic proximity sensors emit high-frequency sound waves and measure the time it takes for the waves to bounce back after hitting an object (e.g., RADAR); photoelectric proximity sensors use light beams to detect the presence or absence of an object (e.g., LIDAR).

In some embodiments, the distance must remain substantially unchanged while the vehicle location has moved a certain distance in order for processor 210 to determine that object 120 and object transport vehicle 160 are associated. This is to eliminate false associations when object transport vehicle 160 is idling in front of an object 120. In some embodiments, the distance object transport vehicle 160 must move before association may be a distance in the coordinate system, or in the form of zones. For example, in lieu of setting this distance to be a number of meters, processor 210 may also set this distance to be a certain number of adjacent zones (i.e., cells of the grid). For example, processor 210 may determine that object 210 and object transport vehicle 160 are associated after they have keep a constant distance from each other when object transport vehicle has moved over 3 zones.

In some embodiments, in step 330B, processor 210 may receive a weight, from the weight sensor, that is carried by object carrier 166 of object transport vehicle 160. In some embodiments, object carrier 166 may monitor the weight it carries, so processor 210 may calculate a weight change on object carrier 166.

In some embodiments, in step 340, processor 210 may determine that the weight carried by object carrier 166 is substantially consistent with the weight of object 120. “Substantially consistent” means within a certain range, or within a certain confidence level. In some embodiments, “substantially consistent” may be related to the accuracy of the weight sensor and certain environmental factors in which the weight sensor operates. In some embodiments, “substantially consistent” may include a certain level of error. For example, the level of error may be 0.1%, 0.2% 0.5%, 1%, 1 ounce, 2 ounces, 0.5 pounds, 1 pound.

In some embodiments, in step 340, processor 210 may prompt a user of object transport vehicle 160 to verify that the correct object 120 is loaded on object carrier 166. In some embodiments, processor 210 may alert the user of object transport vehicle 160 to verify object 120 is indeed loaded on object carrier 166. In some embodiments, the alert may be a message on a displaying device (e.g., an operating screen on object transport vehicle 160 or a handheld device with the user). In some embodiments, the alert may be an audible sound from any device that may be heard by the user. In some embodiments, the alert may be a mechanical (e.g., vibration) signal that may be felt by the user. In some embodiments, the alert may be a combination of visual, audible, and mechanical signals.

In some embodiments, processor 210 may verify that the correct object 120 is loaded on object transport vehicle 160 by having the user scan object 120 loaded on object carrier 166 with a handheld scanning device. In some embodiments, the handheld scanning device may be an optical scanner (e.g., barcode scanner, QR code scanner) or an RFID scanner. In some embodiments, the user may scan tag 180A attached to object 120, or scan a different identification code (e.g., a barcode or QR code).

In some embodiments, in step 345, processor may, depending on the user verification results, determine whether the verification is successful, i.e., whether the correct object 120 is loaded on object carrier 166. In some embodiments, processor 210 may use the scanning result to query database 230 and obtain the information of the scanned object. In some embodiments, processor 210 may confirm whether the scanned object is the correct object 120.

In some embodiments, after verifying the scanned object is the correct object 120 that is loaded to object carrier 166, processor 210 may use the weight of this object to further calibrate the weight sensor. For example, if the weight sensor measured a weight increment that is outside the typical error range, processor 210 may calibrate the weight sensor with the consideration of the weight of the object loaded and its weigh on the records from database 230.

In some embodiments, in step 350, if processor 210 receive a user verification that the correct object 120 is loaded on object carrier 166, processor 210 may then send a destination of object 120 to object transport vehicle 160. In some embodiments, processor 210 may obtain the destination of object 120 by query database 230. In some embodiments, the destination of object 120 may be coded in tag 180A (or in the barcode, QR code, as it may be the identification that was scanned.)

In some embodiments, in step 360, after the object transport vehicle arrives at the destination, processor 210 may send instructions to object transport vehicle 160 to unload object 120. In some embodiments, processor 210 may instruct the user of object transport vehicle 160 to unload object 120 from object carrier 166. In some embodiments, the instruction may be a message on a displaying device (e.g., an operating screen on object transport vehicle 160 or a handheld device with the user.) In some embodiments, the instruction may be an audible sound from any device that may be heard by the user. In some embodiments, the instruction may be a mechanical (e.g., vibration) signal that may be felt by the user. In some embodiments, the instruction may be a combination of visual, audible, and mechanical signals.

In some embodiments, after unloading object 120, processor 210 may determine that object 120 is disassociated with object transport vehicle 160. In some embodiments, making such determination may include steps 370 through 380A and 380B.

In some embodiments, in step 370, processor 210 may update the location of object 120 that is just unloaded and the vehicle location of object transport vehicle 160. In some embodiments, processor 210 may update the location of object 120 in database 230.

In some embodiments, in step 380A, object transport vehicle 160 may start to move without object 120 (i.e., after object 120 is unloaded from object transport vehicle 160.) In some embodiments, processor 210 may consider object 120 successfully unloaded from object transport vehicle 160 if, when object transport vehicle 160 moves, object 120 is not moving with it (i.e., no longer maintains a constant distance between object 120 and object transport vehicle 160.) In some embodiments, processor 210 may use algorithms to remove jitters before calculating distances. Such algorithms may include, for example, Kalman Filter, Moving Average and Exponential Moving Average (EMA), Hidden Markov Models (HMM), etc. In some embodiments, to obtain sufficient certainty, processor 210 may make such determination after object transport vehicle 160 moves over a certain distance. In some embodiments, after object transport vehicle 160 moves a predetermined distance, processor 210 may determine a distance between the latest location of object 120 and the latest vehicle location is above a threshold distance. For example, object transport vehicle 160 may need to move more than 3 zones before processor 210 determines that the distance between the unloaded object 120 and object transport vehicle 160 is above a threshold distance. In some embodiments, the predetermined distance may be a distance in the coordinate system, or in the form of zones. For example, in lieu of having this predetermined distance to be a number of meters, it may also be a certain number of zones. For example, object transport vehicle 160 must have moved at least 3 zones before processor 210 determines that object 120 is more than a certain distance away from object transport vehicle 160 and thus indeed unloaded. This is to eliminate false unload with location determination algorithm causes jittering (i.e., location of tag 180A calculated from tag readers 170 is “jumping around”).

In some embodiments, in step 380B, processor 210 may receive, from the weight sensor, a negative weight change on object carrier 166 of object transport vehicle 160. In some embodiments, object carrier 166 may monitor the weight it carries, so processor 210 may calculate a weight change on object carrier 166. In some embodiments, processor 210 may determine that the weight change is a decrease by a negative increment substantially consistent with the weight of the unloaded object 120. In some embodiments, “substantially consistent” may be related to the accuracy of the weight sensor and certain environmental factors in which the weight sensor operates. In some embodiments, “substantially consistent” may include a certain level of error. For example, the level of error may be 0.1%, 0.2% 0.5%, 1%, 1 ounce, 2 ounces, 0.5 pounds, 1 pound.

In some embodiments, in step 390, processor 210 may disassociate the unloaded object 120 from object transport vehicle 160. In some embodiments, disassociating an object 120 and an object transport vehicle 160 means that their locations are no longer locked together, and that object 120 may no longer have the status of “in transit”. In some embodiments, not having the “in transit” status may mean that object 120 is considered to have a stationary motion status, so when processor 210 calculate its location, jitters may more likely be ignored or averaged out.

In some embodiments, before processor 210 making a determination that the unloaded object 120 is disassociated with object transport vehicle 160, processor 210 may prompt the user of object transport vehicle 160 to verify that the object is unloaded from object transport vehicle 160. In some embodiments, processor 210 may verify that the object is unloaded from object transport vehicle 160 by having the user scan object 120 unloaded from object carrier 166 with a handheld scanning device. In some embodiments, the handheld scanning device may be an optical scanner (e.g., barcode scanner, QR code scanner) or an RFID scanner. In some embodiments, the user may scan tag 180A attached to the unloaded object 120, or scan a different identification code (e.g., a barcode or QR code).

In some embodiments, if in response to the determination in step 345 (i.e., receiving a user verification) that the correct object is not loaded on object transport vehicle 160 (i.e., the object loaded on object transport vehicle 160 is not the correct object), processor 210 may, go directly to step 390 and disassociate the unloaded object 120 from object transport vehicle 160.

In some embodiments, user may decide to override the prompt to verify that the correct object 120 is loaded on object transport vehicle 160. In some embodiments, processor 210 may receive, from the user, an overriding command to the prompt to verify. In some embodiments, after the prompt to verify is overrode, processor 210 may assume that the association between object 120 and object transport vehicle 160 is correct, until receiving other indications otherwise.

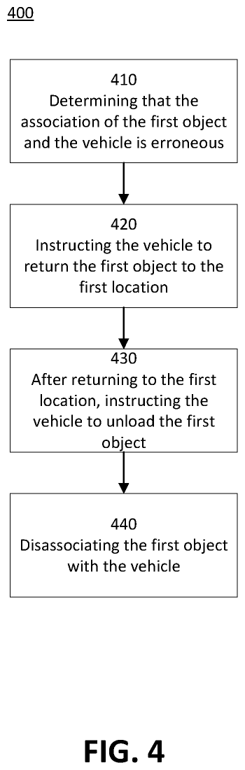

FIG. 4 is a schematic block diagram illustrating an embodiment of a method 400 for disassociating objects to an object transportation vehicle, consistent with embodiments of this disclosure. Specifically, FIG. 4 illustrates a process in a scenario where object transport vehicle 160 carries a wrong object 120 and has moved a certain distance. In some embodiments, in step 410, processor 210 may have a delayed determination that a wrong object 120 is loaded on object carrier 166 of object transport vehicle 160, when object transport vehicle 160 has already carried the wrong object 120 and moved a certain distance away. That is, the association of object 120 and object transport vehicle 160 is erroneous. In some embodiments, this determination may be automatic or manual. For example, processor 210 may notice that the location of an object 120 is moving while it does not have “in transition” status. For example, processor 210 may notice that a changing distance between object transport vehicle 160 and object 120 it should be carrying, i.e., the distance that is supposed to be constant due to object 120 being loaded on object transport vehicle 160, however, is changing above a threshold value. For example, the user of object transport vehicle 160 may notice something not right for any reason using their own judgment and decide to make a confirmation scan during transit.

In some embodiments, in step 420, after determining that the association of the loaded object 120 and object transport vehicle 160 is erroneous, processor 210 may instruct object transport vehicle 160 to return the loaded object 120 back to its original location before being picked up. In some embodiments, such instruction may include updating and sending destination to object transport vehicle 160.

In some embodiments, in step 430, after object transport vehicle 160 returning to the original location of the loaded object 120 (i.e., where the object was loaded), processor 210 may instruct object transport vehicle 160 to unload the loaded object, and put it back to its original location.

In some embodiments, in step 440, processor 210 may then disassociate object 120 with object transport vehicle 160.

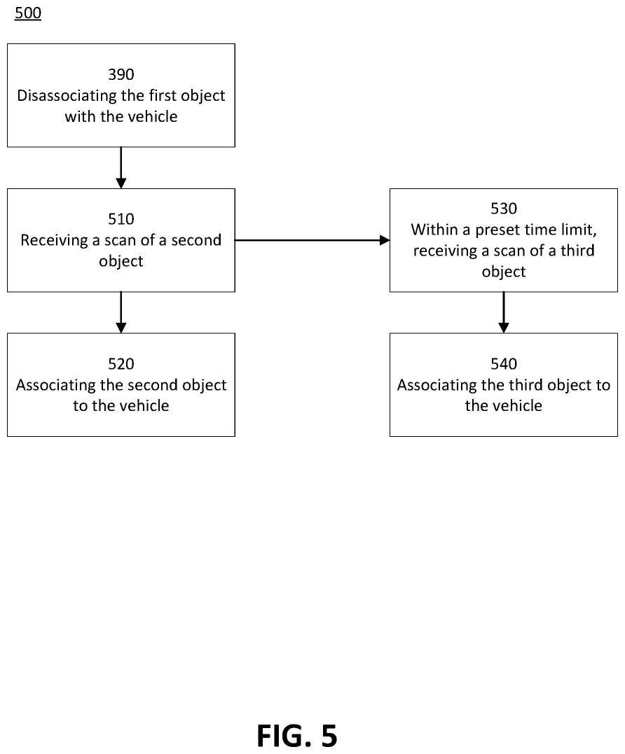

FIG. 5 is a schematic block diagram illustrating an embodiment of a method 500 for associating objects to an object transportation vehicle, consistent with embodiments of this disclosure. As shown in FIG. 5, in some embodiments, after disassociating the wrong object with object transport vehicle 160 (as in step 390), in step 510, processor 210 may receive, from the user using their handheld scanning device, a scan of a second object having its location and weight.

In some embodiments, in step 520, processor 210 may associate the scanned second object with object transport vehicle 160, recognizing the second object 120 as the correct object that is supposed to be loaded to object transport vehicle 160.

In some embodiments, in step 530, the user may, within a preset time limit that is relatively short (i.e., on the order of seconds, for instance, 5 seconds or 10 seconds), processor may receive, from the user using their handheld scanning device, another scan of a third object having its location and weight.

In some embodiments, having two consecutive scans within a short period of time may indicate that the first scan was made in mistake. Therefore, processor 210 may discard the first of the two scans and recognize only the later scan.

In some embodiments, in step 540, processor 210 may associate the third object 120 with object transport vehicle 160, recognizing the third object 120 as the correct object that is supposed to be loaded to object transport vehicle 160, and ignoring the second object.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, HTML with included Java applets, or Golang.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system for associating an object transport vehicle to an object, comprising:
an object transport vehicle, the object transport vehicle comprising an object carrier, a weight sensor configured to measure weight on the object carrier, and at least two first tags providing locations of the object carrier, the object transport vehicle is configured to transport objects with a second tag;
at least one processor; and
at least one non-transitory memory storing instructions, when executed by the at least one processor, perform steps of:
receiving a first location and a first weight of a first object, the first object associated with the second tag;
receiving a vehicle location of the object transport vehicle based on the at least two first tags;
receiving, from the weight sensor, a weight carried by the object carrier; and
determining that the first object and the object transport vehicle are associated by:
determining a first distance between the first location and the vehicle location remains below a threshold distance based on determining that the object transport vehicle has moved by at least a predetermined distance; and
determining that the weight carried by the object carrier is substantially consistent with the first weight; and
prompting a user of the object transport vehicle to verify that the first object is loaded on the object carrier;
in response to receiving a user verification that the first object is loaded on the object carrier:
sending to the object transport vehicle a destination of the first object; and
after the object transport vehicle arrives at the destination, sending instructions to the object transport vehicle to unload the first object; and
in response to receiving a user verification that the first object is not loaded on the object transport vehicle:
disassociating the first object to the object transport vehicle.

2. The system of claim 1, the steps further comprising
after unloading the first object, determining that the first object is disassociated with the object transport vehicle by:
updating the first location of the first object and the vehicle location;
after the object transport vehicle moves a second predetermined distance, determining a second distance between the updated first location and the updated vehicle location is above a second threshold distance;
receiving, from the weight sensor, a weight change on the object carrier; and
determining that the weight change is a decrease by an increment substantially consistent with the weight of the first object.

3. The system of claim 2, wherein determining that the first object is disassociated with the object transport vehicle further comprising prompting a user to verify that the first object is unloaded from the object transport vehicle.

4. The system of claim 1, the steps further comprising:
receiving, from the user, a scan of a second object having a second location and a second weight; and
associating the second object with the object transport vehicle.

5. The system of claim 4, the steps further comprising:
after receiving the scan of the second object, within a preset time limit, receiving, from the user, a scan of a third object having a third location and a third weight;
disassociating the first object and the second object with the object transport vehicle; and
associating the third object with the object transport vehicle.

6. The system of claim 1, the steps further comprising:
determining that the association of the first object and the object transport vehicle is erroneous;
instructing the object transport vehicle to return the first object to the first location;
after the object transport vehicle returning to the first location, instructing the object transport vehicle to unload the first object; and
disassociating the first object with the object transport vehicle.

7. The system of claim 1, wherein verifying that the first object is loaded on the object transport vehicle comprises the user scanning the first object.

8. The system of claim 1, wherein verifying that the first object is loaded on the object transport vehicle comprises receiving, from the user, an overriding command to the prompt to verify.

9. The system of claim 1, wherein the first object has a first tag attached to the first object, the first tag is configured to provide the first location of the first object.

10. The system of claim 1, wherein the object transport vehicle has at least two tags attached to the object transport vehicle, one of the at least two tags is located on a front end of the object transport vehicle, the other one of the at least two wireless tags is located on a back end of the object transport vehicle.

11. A method for associating an object transport vehicle to an object, comprising:
receiving a vehicle location of the object transport vehicle, the object transport vehicle comprising an object carrier, a weight sensor configured to measure weight on the object carrier, and at least two first tags providing locations of the object transport vehicle, the object transport vehicle is configured to transport objects with a second tag;
receiving a first location and a first weight of a first object, the first object being associated with the second tag; and
receiving, from the weight sensor, a weight carried by the object carrier;
determining that the first object and the object transport vehicle are associated by:
determining a first distance between the first location and the vehicle location remains below a threshold distance based on determining that the object transport vehicle has moved by at least a predetermined distance; and
determining that the weight carried by the object carrier is substantially consistent with the first weight of the first object; and
prompting a user of the object transport vehicle to verify that the first object is loaded on the object carrier;
in responding to receiving a user verification that the first object is loaded on the object carrier:
sending to the object transport vehicle a destination of the first object; and
after the object transport vehicle arrives at the destination, sending instructions to the object transport vehicle to unload the first object; and
in responding to receiving a user verification that the first object is not loaded on the object transport vehicle:
disassociating the first object to the object transport vehicle.

12. The method of claim 11, further comprising
after unloading the first object, determining that the first object is disassociated with the object transport vehicle by:
updating the first location of the first object and the vehicle location;
on or before the object transport vehicle moves a second predetermined distance, determining a second distance between the updated first location and the updated vehicle location is above a second threshold distance;
receiving, from the weight sensor, a weight change on the object carrier; and
determining that the weight change is a decrease by an increment substantially consistent with the weight of the first object.

13. The method of claim 12, wherein determining that the first object is disassociated with the object transport vehicle further comprising prompting a user to verify that the first object is unloaded from the object transport vehicle.

14. The method of claim 11, further comprising:
receiving, from the user, a scan of a second object having a second location and a second weight;
disassociating the first object with the object transport vehicle; and
associating the second object with the object transport vehicle.

15. The method of claim 14, further comprising:
after receiving the scan of the second object, within a preset time limit, receiving, from the user, a scan of a third object having a third location and a third weight;
disassociating the first object and the second object with the object transport vehicle; and
associating the third object with the object transport vehicle.

16. The method of claim 11, further comprising:
determining that the association of the first object and the object transport vehicle is erroneous;
instructing the object transport vehicle to return the first object to the first location;
after the object transport vehicle returning to the first location, instructing the object transport vehicle to unload the first object; and
disassociating the first object with the object transport vehicle.

17. The method of claim 11, wherein verifying that the first object is loaded on the object transport vehicle comprises the user scanning the first object.

18. The system of claim 1, wherein verifying that the first object is loaded on the object transport vehicle comprises receiving, from the user, an overriding command to the prompt to verify.

19. The method of claim 11, wherein the first object has a first tag attached to the first object, the first tag is configured to provide the first location of the first object.

20. The method of claim 11, wherein the object transport vehicle has at least two tags attached to the object transport vehicle, one of the at least two tags is located on a front end of the object transport vehicle, the other one of the at least two wireless tags is located on a back end of the object transport vehicle.
